(19) United States
(12) Patent Application Publication
(10) Pub. No.: US 2019/0039462 A1
(43) Pub. Date: Feb. 7, 2019

(54) VEHICLE CHARGING SYSTEM, PARKING LOT SYSTEM, AND VEHICLE CHARGING METHOD

(71) Applicant: NEC Corporation, Tokyo (JP)

(72) Inventors: Yasuaki KONDO, Tokyo (JP); Yuichiro FUKUBAYASHI, Tokyo (JP)

(73) Assignee: NEC Corporation, Tokyo (JP)

(21) Appl. No.: 16/084,215

(22) PCT Filed: Mar. 16, 2017
(86) PCT No.: PCT/JP2017/010642

§ 371 Date: Sep. 11, 2018

(30) Foreign Application Priority Data
Mar. 17, 2016 (JP) 2016-053407

(51) Int. Cl. B60L 11/18; E04H 6/42; G06Q 50/06; G06Q 50/10; H02J 50/10; H02J 50/80; H02J 7/00

(52) U.S. Cl. CPC B60L 11/18; E04H 6/42; G06Q 50/06; B60M 7/00; H02J 50/10; H02J 50/80; H02J 7/00; G06Q 50/10

(57) ABSTRACT

A vehicle charging system includes: a non-contact charging apparatus that performs non-contact charging on a battery of a vehicle by facing a power receiving coil mounted on the vehicle; an information acquisition part configured to acquire, from the vehicle, information for determining whether to allow charging on the vehicle; and a charging control part configured to control a charging operation of the charging apparatus based on information acquired by the information acquisition part.

### REFERENCE TO RELATED APPLICATION

This application is a national stage application of International Application No. PCT/JP2017/010642 entitled Vehicle Charging System, and Vehicle Charging Method,” filed on Mar. 17, 2016, which claims priority to Japanese Patent Application No. 2016-053407 filed on Mar. 17, 2016, the disclosures of which are hereby incorporated by reference in their entirety.

### FIELD

The present invention relates to a vehicle charging system, a parking lot system, and a vehicle charging method. In particular, it relates to a vehicle charging system, a parking lot system, and a vehicle charging method for performing non-contact charging on batteries mounted on vehicles.

### BACKGROUND

In recent years, methods for performing non-contact charging on batteries mounted on vehicles have been discussed. For example, PTLs 1 to 3 disclose configurations in which charging is performed by disposing a non-contact charging apparatus on a road surface or a parking lot and moving a vehicle to a charging space where this charging apparatus is disposed. For example, PTL 1 discloses a configuration that enables charging on a vehicle 2 during parking by disposing, on a bottom surface of the vehicle 2, a power receiving part 21 that receives power from a power feeding part 31 embedded in a road surface of a parking space 3 through electromagnetic induction.

PTL 4 discloses a configuration in which parking rights are checked by, instead of having a parking lot attendant check parking tickets, previously registering captured images of license plates and corresponding parking areas associated with each other in a database and checking the database for the correspondence between a parking area and a license plate.

### PATENT LITERATURE (PTL)

PTL 1: Japanese Patent Kokai Publication No. JP2010-226945A

### PTL 2: International Publication No. 2012/042902

PTL 3: Japanese Patent Kokai Publication No. JP2013-34369A
PTL 4: Japanese Patent Kokai Publication No. JP2015-179531A

### SUMMARY

The following analysis has been given by the present inventor. According to the charging systems in PTLs 1 to 3, when a user charges a vehicle, the user does not need to insert a charging plug into the charging port on the vehicle body. However, the user needs to get out of his/her vehicle, to prove to a charging apparatus that the user has the right to receive a charging service, and this is considered as a problem. In this wired charging service using a charging plug, an individual user is requested to pay the cost of charging by an integrated circuit (IC) card or a credit card.

For example, PTL 4 proposes a parking fee payment method. However, in the case of non-contact charging, in view of the cost of a charging facility, a method in which a charging space is provided separately from a parking area has been proposed. Thus, the content in PTL 4 cannot directly be applied, which is considered as a problem.

It is an object of the present invention to provide a vehicle charging system, a parking lot system, and a vehicle charging method that contribute to improving convenience of a charging system in which a plurality of vehicles are charged by using a non-contact charging apparatus as described above.

According to a first aspect, there is provided a vehicle charging system including a non-contact charging apparatus that performs non-contact charging on a battery of a vehicle by facing a power receiving coil mounted on the vehicle. This vehicle charging system further includes: an information acquisition part configured to acquire, from the vehicle, information for determining whether to allow charging on the vehicle; and a charging control part configured to control a charging operation of the charging apparatus based on information acquired by the information acquisition part.

According to a second aspect, there is provided a parking lot system including: a non-contact charging apparatus that performs non-contact charging on a battery of a vehicle by facing a power receiving coil mounted on the vehicle; an information acquisition part configured to acquire, from the vehicle, information for determining whether to allow charging on the vehicle; a charging control part configured to control a charging operation of the charging apparatus based on information acquired by the information acquisition part; and a vehicle movement part configured to move a vehicle that has been charged from a place where the charging apparatus is installed.

According to a third aspect, there is provided a vehicle charging method including: causing a charging control apparatus, which is included in a vehicle charging system including a non-contact charging apparatus that performs non-contact charging on a battery of a vehicle by facing a power receiving coil mounted on the vehicle and an information acquisition part configured to acquire, from the vehicle, information for determining whether to allow charging on the vehicle, to acquire, from the vehicle, information for determining whether to allow charging on the vehicle; and causing the charging control apparatus to control a charging operation of the charging apparatus based on the acquired information. This method is associated with a certain machine, i.e., a vehicle charging system that performs non-contact charging on a plurality of vehicles.

The meritorious effects of the present invention are summarized as follows.

The present invention can improve convenience of a charging system in which vehicles are charged by using a non-contact charging apparatus as described above.

### BRIEF DESCRIPTION OF DRAWINGS

FIG. 1 illustrates a configuration according to an exemplary embodiment of the present disclosure.

FIG. 2 illustrates a configuration of a vehicle charging system according to a first exemplary embodiment of the present disclosure.

FIG. 3 illustrates an example of information that the vehicle charging system according to the first exemplary embodiment of the present disclosure uses as information for determining whether to allow charging.

FIG. 4 is a sequence diagram illustrating an operation of the vehicle charging system according to the first exemplary embodiment of the present disclosure.

FIG. 5 illustrates a configuration of a vehicle charging system according to a second exemplary embodiment of the present disclosure.

FIG. 6 illustrates an example of information that the vehicle charging system according to the second exemplary embodiment of the present disclosure uses as information for determining whether to allow charging.

FIG. 7 illustrates another example of the information that the vehicle charging system according to the second exemplary embodiment of the present disclosure uses as information for determining whether to allow charging.

FIG. 8 illustrates an example of information that a vehicle charging system according to a third exemplary embodiment of the present disclosure uses as information for determining whether to allow charging.

FIG. 9 illustrates a configuration of a vehicle charging system according to a fourth exemplary embodiment of the present disclosure.

FIG. 10 illustrates an example of information held in the vehicle charging system according to the fourth exemplary embodiment of the present disclosure.

FIG. 11 is a sequence diagram illustrating an operation of the vehicle charging system according to the fourth exemplary embodiment of the present disclosure.

FIG. 12 illustrates a configuration of a vehicle charging system according to a fifth exemplary embodiment of the present disclosure.

FIG. 13 is a sequence diagram illustrating an operation of the vehicle charging system according to the fifth exemplary embodiment of the present disclosure.

FIG. 14 illustrates a configuration of a vehicle charging system according to a sixth exemplary embodiment of the present disclosure.

### PREFERRED MODES

First, an outline of an exemplary embodiment of the present disclosure will be described with reference to a drawing. Reference characters in the following outline denote various elements for the sake of convenience and are used as examples to facilitate understanding of the present disclosure. Namely, the reference characters are not intended to limit the present disclosure to the illustrated modes. An individual connection line between blocks in any of the drawings used in the following description signifies both one-way and two-way directions. An individual arrow schematically illustrates the principal flow of a signal (data) and does not exclude bidirectionality. In addition, although there are ports or interfaces at the connection points of the input and output of each block in the figures, they are omitted.

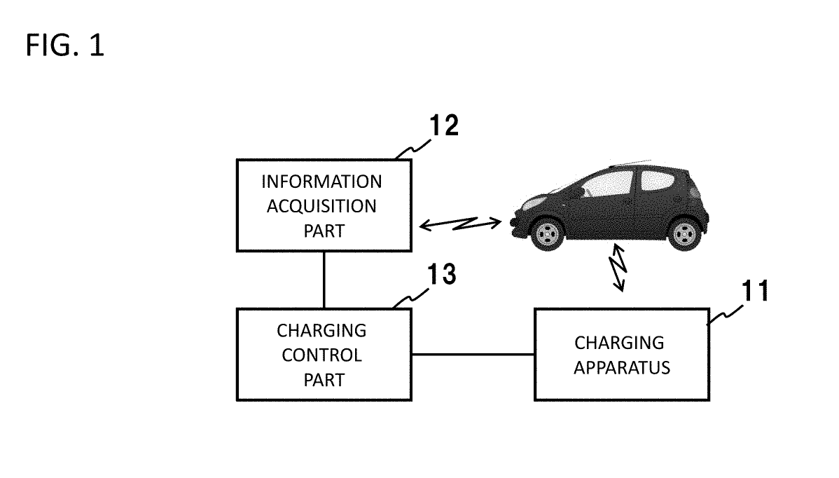

As illustrated in FIG. 1, an exemplary embodiment of the present disclosure can be realized by a vehicle charging system including: a non-contact charging apparatus 11 that performs non-contact charging on a battery of a vehicle by facing a power receiving coil mounted on the vehicle; an information acquisition part 12; and a charging control part 13.

More specifically, the information acquisition part 12 acquires, from the vehicle, information for determining whether to allow charging on the vehicle. Any information can be used as the information for determining whether to allow charging. For example, information indicating users of a non-contact charging service using the charging apparatus 11 may be used. This information acquisition part 12 can simply be realized by an apparatus (a bar code reader or a radio frequency identification (FRID) communication apparatus) that reads a bar code or an RFID attached to a part of the body of an individual vehicle. Alternatively, a device having a wireless communication function such as iBeacon and Eddystone using Bluetooth Low Energy (BLE) may be attached to the body of the vehicle, and the information acquisition part 12 may be configured to acquire information for determining whether to allow charging from this device (“BlueTooth”, “iBeacon”, and “Eddystone” are registered trademarks).

The charging control part 13 controls an operation of the charging apparatus 11 based on the information acquired by the information acquisition part 12. Specifically, the charging control part 13 gives the charging apparatus 11 an instruction for allowing or denying charging on the vehicle. By adopting the above configuration, the driver of the vehicle can receive a charging service without getting out of his/her vehicle.

In the present description, the term “acquisition” includes active acquisition and passive acquisition. Active acquisition signifies a case in which an apparatus acquires data or information stored in a different apparatus or a storage medium. Examples of the case include a case in which an apparatus transmits a request or a query to a different apparatus and receives data or information from the different apparatus and a case in which an apparatus accesses a different apparatus or a storage medium and reads out data or information. Passive acquisition includes at least one of a case in which data or information outputted from a different apparatus is inputted to an apparatus (passive reception) and a case in which an apparatus receives distributed (or transmitted, push-notified, etc.) data or information. In addition, the active acquisition includes a case in which an apparatus selectively acquires data or information of all the data received thereby, and the passive acquisition includes a case in which an apparatus selectively receives distributed data or information.

### First Exemplary Embodiment

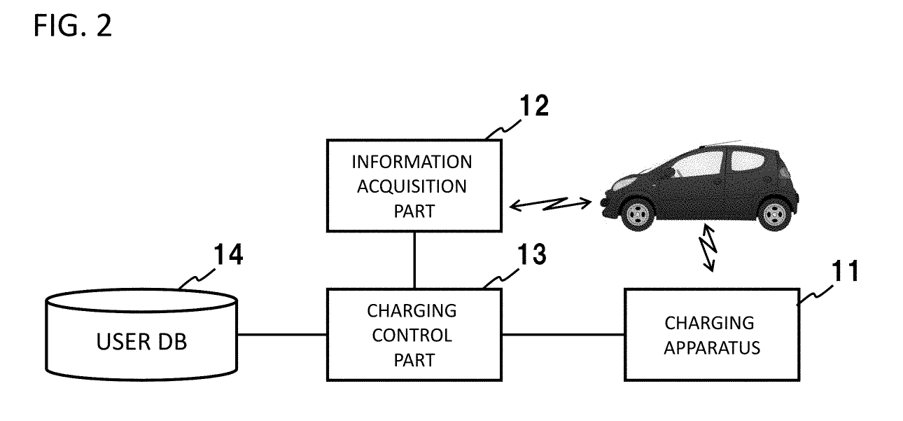

Next, a first exemplary embodiment of the present disclosure will be described in detail with reference to drawings. FIG. 2 illustrates a configuration of a vehicle charging system according to the first exemplary embodiment of the present disclosure. As illustrated in FIG. 2, the configuration includes a charging apparatus 11, an information acquisition part 12, a charging control part 13, and a user database (hereinafter, referred to as a user DB) 14.

The charging apparatus 11 is a non-contact charging apparatus that performs non-contact charging on a battery of a vehicle by facing a power receiving coil (a charging port) mounted on the vehicle. The non-contact charging method is not particularly limited. For example, an electromagnetic induction method or a resonance method may be used. When the resonance method is used, power is transmitted from a power transmitting coil included in the charging apparatus 11 to the power receiving coil by coupled resonance (resonance) between a circuit having the power transmitting coil and a circuit having the power receiving coil. More specifically, for example, a power-transmitting resonance circuit is formed with a capacitor in the circuit having the power transmitting coil, and a power-receiving resonance circuit is formed with a capacitor in the circuit having the power receiving coil. The same resonance frequency is set between the power transmitting circuit and the power receiving circuit so that coupled resonance is produced between the power-transmitting resonance circuit and the power-receiving resonance circuit at this frequency. In this way, the charging apparatus 11 can transmit power to the vehicle without bringing the power transmitting coil and the power receiving coil to mechanically come into contact with each other.

The user DB 14 is a database that holds information about users of a charging service using the above non-contact charging apparatus 11. In the present exemplary embodiment, information stored in the user DB 14 illustrated in FIG. 3 is used as information for determining whether to allow charging. In the example in FIG. 3, information about the license plates of vehicles of the users are registered as vehicle IDs, per user.

As the information acquisition part 12, for example, a reading device that captures an image of a license plate of a vehicle that has stopped at a position where the charging apparatus 11 can perform charging and reads information about the license plate of the vehicle from the captured image can be used. For example, an optical character reader (OCR) can be used as the above device.

When the charging control part 13 receives license plate information from the information acquisition part 12, the charging control part 13 checks whether the corresponding license plate is registered in the user DB 14 illustrated in FIG. 3. As a result of the checking, if the corresponding license plate is registered in the user DB 14, the charging control part 13 instructs the charging apparatus 11 to perform a charging operation.

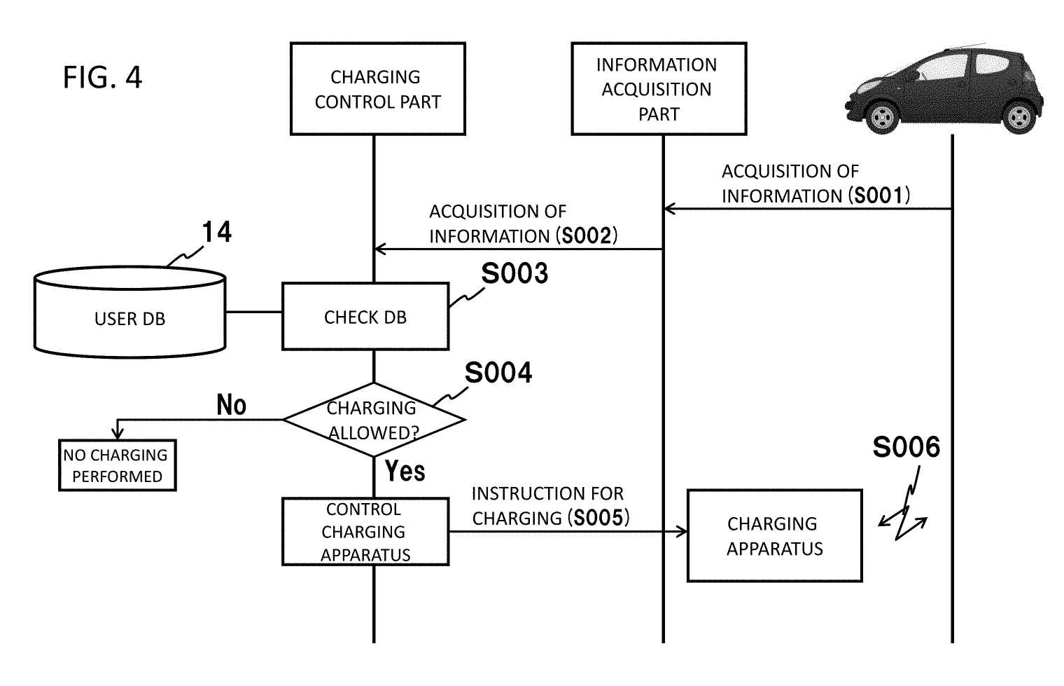

Next, an operation according to the present exemplary embodiment will be described in detail with reference to a drawing. FIG. 4 is a sequence diagram illustrating an operation of the vehicle charging system according to the first exemplary embodiment of the present disclosure. As illustrated in FIG. 4, first, the information acquisition part 12 reads license plate information from a vehicle (step S001: acquisition of information).

Next, the information acquisition part 12 transmits the read license plate information to the charging control part 13 (step S002; acquisition of information).

After receiving the information, the charging control part 13 checks whether the corresponding license plate is registered in the user DB 14 (step S003). As a result of the checking, if the corresponding license plate is registered in the user DB 14 (Yes in step S004), the charging control part 13 instructs the charging apparatus 11 to perform a charging operation (step S005).

In accordance with the instruction from the charging control part 13, the charging apparatus 11 starts to perform the charging operation on the vehicle (step S006). In step S004, if the corresponding license plate is not registered in the user DB 14 (No in step S004), the charging control part 13 does not instruct the charging apparatus 11 to perform the charging operation.

As described above, according to the present exemplary embodiment, a highly convenient configuration can be achieved. Namely, whether to allow charging on a vehicle can be determined by using the license plate information of the vehicle. In addition, according to the present exemplary embodiment, since the user does not need to actually operate the charging apparatus 11 to prove that the user has the right to receive the charging service, the body of the charging apparatus 11 can be downsized. In addition, the charging apparatus 11 can be installed at various places.

In the above exemplary embodiment, while the license plate information is used as the information for determining whether to allow charging, various kinds of information may be used as the information for determining whether to allow charging. For example, a bar code, an identification plate, an IC card, or an RFID, in which information indicating that a corresponding user is a subscriber of the charging service is recorded, may be attached to a side or bottom surface of a vehicle, and the information acquisition part 12 may be configured to read the information. Alternatively, in place of the configuration using the above dedicated medium, an image of a vehicle, an image of a user, or a feature amount obtained from these images may be used.

### Second Exemplary Embodiment

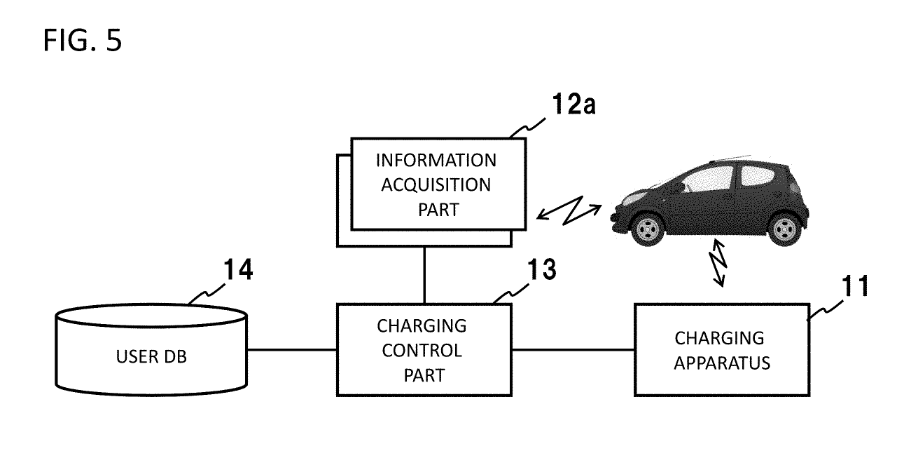

Next, a second exemplary embodiment obtained by changing the above first exemplary embodiment will be described in detail with reference to drawings. FIG. 5 illustrates a configuration of a vehicle charging system according to the second exemplary embodiment of the present disclosure. This configuration differs from that according to the first exemplary embodiment illustrated in FIG. 2 in that the configuration includes information acquisition part 12a that can acquire a plurality of kinds of information. Since other basic configurations and operations according to the second exemplary embodiment are the same as those according to the first exemplary embodiment, the following description will be made with a focus on the difference.

The information acquisition part 12a acquires two or more kinds of information as the information for determining whether to allow charging. While a plurality of information acquisition parts 12a are arranged in the example in FIG. 5, a single apparatus may be used as long as the apparatus can acquire the plurality of kinds of information.

FIG. 6 illustrates an example of information held in a user DB 14 according to the second exemplary embodiment of the present disclosure. In the present exemplary embodiment, as the information for determining whether to allow charging, tag information obtained from RFIDs is registered as second authentication information, in addition to the license plate information (first authentication information).

Thus, the information acquisition part 12a acquires tag information obtained from an RFID, in addition to the above license plate information.

Next, if each item of information received from the information acquisition part 12a is registered in the user DB 14, charging control part 13 instructs a charging apparatus 11 to perform a charging operation.

In addition to the advantageous effects provided by the above first exemplary embodiment, the second exemplary embodiment of the present disclosure can provide an advantageous effect of preventing unauthorized provision of a charging service, which could occur otherwise if the first authentication information is forged or stolen.

In addition, while the tag information obtained from an RFID has been used as the second authentication information in the above description, information usable as the first authentication information described above may be used in combination with the license plate information. For example, as illustrated in FIG. 7, a combination of the license plate information of a vehicle and feature information obtained from an image of the vehicle may be used for determining whether to allow charging. In addition, in place of the license plate information, information acquired from the above-mentioned bar code, identification plate, IC card, RFID, etc. may be used.

### Third Exemplary Embodiment

Next, a third exemplary embodiment obtained by changing the above second exemplary embodiment will be described in detail with reference to a drawing. FIG. 8 illustrates an example of information held in a user DB 14 according to the third exemplary embodiment of the present disclosure. In the present exemplary embodiment, in addition to the information for determining whether to allow charging, a field “charging condition” which is used for determining whether to allow charging is added to the user DB 14.

Charging control part 13 according to the present exemplary embodiment also serves as second information acquisition part configured to acquire charging condition information and determines whether each item of information received from information acquisition part 12a is registered in the user DB 14 and whether a corresponding condition(s) set as the field “charging condition” is satisfied. For example, in the case of a user A in FIG. 8, a condition “the unit charging price is XX yen or less” is set. Thus, the corresponding vehicle of the user A will not be charged if the unit charging price is over XX yen. Conditions other than the unit charging price at a charging apparatus 11 and the unit charging price specified by the user may be used. For example, whether to allow charging may be determined based on whether the unit charging price at the charging apparatus 11 falls within a unit charging price range specified by a user. Namely, the charging control part 13 controls the charging operation of the charging apparatus based on the price for the charging operation of the charging apparatus 11 and a unit charging price.

For example, in the case of a user B in FIG. 8, a condition “charging is not performed if the state of charge (SOC) of the storage battery of the corresponding vehicle of the user B is YY% or more” is set. Thus, the vehicle of the user B will not be charged if the SOC of the storage battery of the vehicle is YY% or more. Conditions other than the comparison between the SOC of the storage battery and the threshold YY% may be used. For example, the charging control part 13 may determine that charging is performed when the SOC of the storage battery falls within a predetermined range and that charging is not performed otherwise. In other words, charging is not performed when the SOC is low or when the SOC indicates a predetermined value or more. This is because, when the SOC is extremely low, use of a fast charging apparatus using a wired system or a plug-in system could be more suitable. Namely, the charging control part 13 controls the charging operation of the charging apparatus 11 based on a volume of the free capacity of the storage battery.

In addition to the advantageous effects provided by the above first and second exemplary embodiments, the third exemplary embodiment of the present disclosure can provide an advantageous effect of providing a finer charging service. Since the charging conditions illustrated in FIG. 8 are merely examples of possible charging conditions, other conditions may also be set. For example, conditions “charging is not performed near home”, “charging is not performed during the daytime”, and “charging is performed if the SOC is below a predetermined lower threshold, regardless of the above conditions” may be set.

In addition, execution of a user approval operation and a user authentication operation before the start of charging may be used as a charging condition. In this way, unintended charging, e.g., charging on a stolen vehicle, can be prevented. In particular, since charging on a stolen vehicle is prevented, even is a vehicle is stolen, the stolen vehicle can only travel with the amount of electricity charged at that point.

In addition, in the third exemplary embodiment, it is preferable that individual users be able to freely update their own charging conditions in the user DB 14. In addition, it is also preferable that combinations of charging conditions be set as templates and that a user interface, with which the users can select a template as needed, be prepared.

### Fourth Exemplary Embodiment

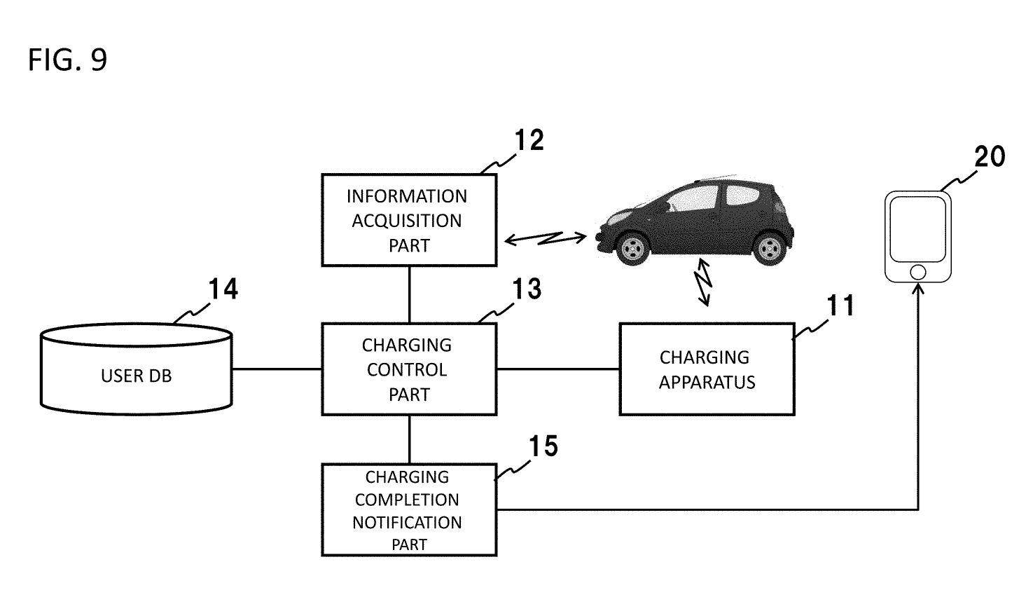

Next, a fourth exemplary embodiment will be described in detail with reference to drawings. In the fourth exemplary embodiment, information obtained from information acquisition part 12 is used as information for determining whether a vehicle exists in a charging space, and, after a vehicle is charged, the user of the vehicle is notified of the completion of the charging. FIG. 9 illustrates a configuration of a vehicle charging system according to the fourth exemplary embodiment of the present disclosure. This configuration differs from that according to the first exemplary embodiment illustrated in FIG. 2 in that charging completion notification part 15 is connected to charging control part 13. Since other basic configurations and operations according to the fourth exemplary embodiment are the same as those according to the first to third exemplary embodiments, the following description will be made with a focus on the difference.

FIG. 10 illustrates an example of information held in a user DB 14 according to the fourth exemplary embodiment of the present information. In the present exemplary embodiment, the user DB 14 includes a field in which mail addresses of users are stored and a field in which flags indicating whether charging has been completed are stored, in addition to information for determining whether to allow charging.

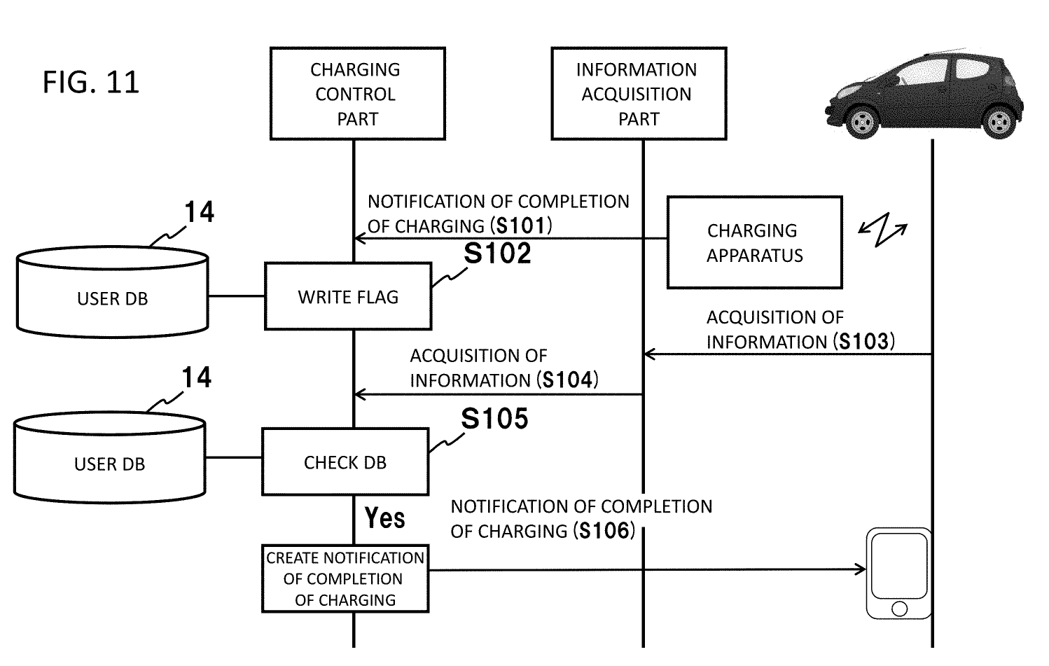

FIG. 11 is a sequence diagram illustrating an operation of the vehicle charging system according to the fourth exemplary embodiment of the present disclosure. Since the operation from the acquisition of information about the target vehicle to the start of charging is the same as that according to the first exemplary embodiment, description thereof will be omitted.

As illustrated in FIG. 11, first, when the charging on the vehicle has been completed, a charging apparatus 11 notifies the charging control part 13 of the completion of the charging (step S101). While the charging apparatus 11 actively notifies the charging control part 13 of the completion of the charging in the example in FIG. 11, the charging control part 13 may query the charging apparatus 11 about whether the charging has been completed.

When receiving the notification of the completion of the charging, the charging control part 13 records a predetermined value (for example, “1”), which indicates the completion of the charging, in a corresponding entry in the user DB 14, the entry being under the charging completion flag field (step S102). If the charging completion flag corresponding to a vehicle represents the predetermined value indicating the completion of charging and if the charging control part 13 still keeps receiving the information for determining whether to allow charging from the information acquisition part 12 (steps S103 and S104), the charging control part 13 reads contact information (a mail address) of the corresponding user from the user DB 14 (step S105; check DB).

Next, the charging control part 13 creates a charging completion notification addressed to the read contact information (the mail address) and transmits the notification thereto (step S106).

In addition to the advantageous effects provided by the above first and second exemplary embodiments, the fourth exemplary embodiment of the present disclosure can provide an advantageous effect of notifying individual users of the completion of their charging. In addition, since users are expected to move their vehicles promptly when receiving the above notifications, the utilization rate of the charging apparatus 11 can be improved. Of course, information about an incentive for moving their vehicles, information about billing, information about a penalty for not moving their vehicles, etc. may be included in the charging completion notifications. In addition, if the charging control part 13 keeps receiving the information for determining whether to allow charging from the information acquisition part 12 for a predetermined time after the transmission of a charging completion notification, namely, if a vehicle is still occupying the charging space, the charging completion notification may be transmitted again.

While mail addresses are used as the contact information about the users in the example in FIG. 10, mobile phone numbers, contact IDs, etc. may alternatively be used. Of course, a plurality of kinds of contact information may be registered per user, and contact information may be selected based on a condition set per user. In addition, if the charging completion timing can be predicted from information obtained from the charging apparatus 11, notice mail, etc. indicating the charging completion timing may be transmitted to the corresponding user. In addition, instead of contacting the individual user, an administrator or the like of a parking lot or an associated facility may be notified of identification information about an occupied charging apparatus or charging space (for example, a charging apparatus at number N on the first floor). Based on this notification, the administrator or the like of the parking lot or the associated facility can make an announcement or the like in the relevant facility so that the corresponding user can be requested to move his/her vehicle promptly.

### Fifth Exemplary Embodiment

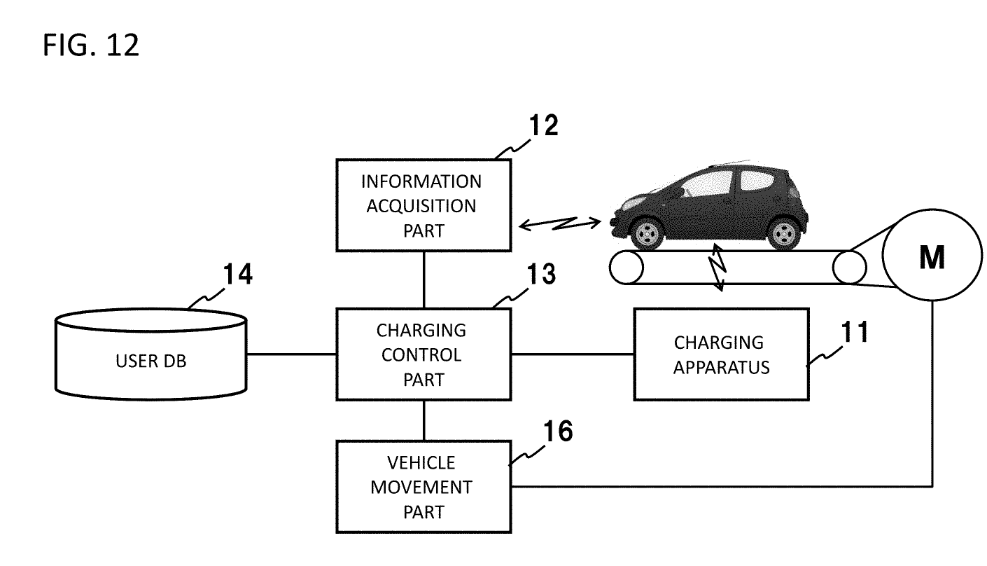

Next, a fifth exemplary embodiment will be described in detail with reference to drawings. The fifth exemplary embodiment further includes a function of moving vehicles that have been charged. FIG. 12 illustrates a configuration of a vehicle charging system according to the fifth exemplary embodiment of the present disclosure. This configuration differs from that according to the first exemplary embodiment illustrated in FIG. 2 in that a vehicle movement part 16 is connected to a charging control part 13. Since other basic configurations and operations according to the fifth exemplary embodiment are the same as those according to the first to fourth exemplary embodiments, the following description will be made with a focus on the difference.

A motor that can move a pallet or the like on which a vehicle is mounted can be used as the vehicle movement part 16. As a different mode of the vehicle movement part, a pallet-less type vehicle moving mechanism that exchanges a vehicle by using comb-teeth arms may alternatively be used, instead of pallet-type vehicle movement part. The destination of the vehicle may be a parking space dedicated for vehicles that has been charged, for example.

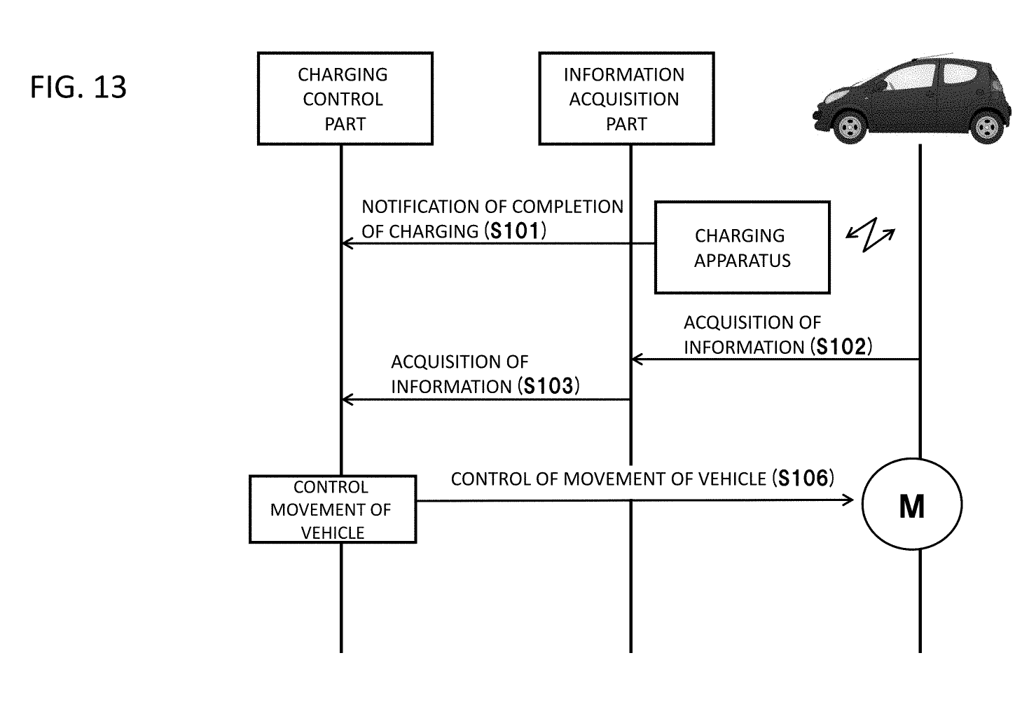

FIG. 13 is a sequence diagram illustrating an operation of the vehicle charging system according to the fifth exemplary embodiment of the present disclosure. Since the operation from the acquisition of charging information about the target vehicle to the start of charging is the same as that according to the first and second exemplary embodiments, description thereof will be omitted.

As illustrated in FIG. 13, first, when the vehicle has been charged, the charging apparatus 11 notifies the charging control part 13 of the completion of the charging (step S101). While the charging apparatus 11 actively notifies the charging control part 13 of the completion of the charging in the example in FIG. 13, the charging control part 13 may query the charging apparatus 11 about whether the charging has been completed.

After receiving the notification of the completion of the charging, if the charging control part 13 still keeps receiving the information for determining whether to allow charging from the information acquisition part 12 (steps S102 and S103), the charging control part 13 determines that the vehicle needs to be moved and instructs the vehicle movement part 16 to move the vehicle (step S106; control of movement of vehicle).

In addition to the advantageous effects provided by the above first and second exemplary embodiments, the fifth exemplary embodiment of the present disclosure can provide an advantageous effect of improving the utilization rate of the charging apparatus 11 by promptly moving an individual vehicle that has been charged from the installation place of the charging apparatus 11.

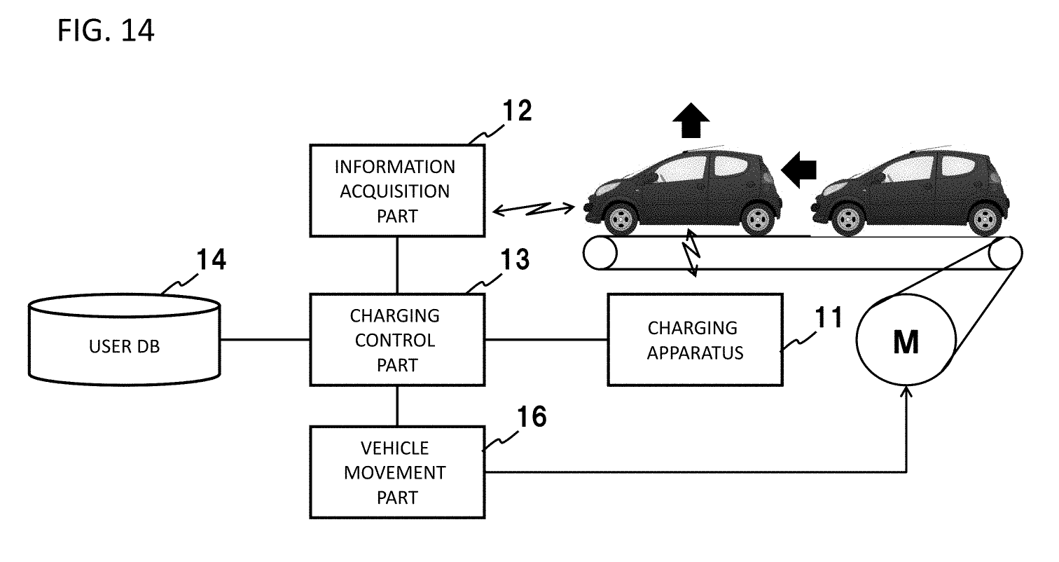

While an individual vehicle that has been charged is moved in the fifth exemplary embodiment, the following variation (a sixth exemplary embodiment) may be used for a mechanical parking facility. As illustrated in FIG. 14, when a plurality of vehicles are mounted on pallets or the like in a mechanical parking facility, the vehicle movement part 16 may move a vehicle that has been charged from the installation place of the charging apparatus 11 and move the next charging target vehicle to the installation place. Namely, the present disclosure is applicable to a parking lot system. In addition, the sixth exemplary embodiment can further improve the utilization rate of the charging apparatus 11, compared with those according to the fourth and fifth exemplary embodiments.

In addition, each of the functional part of the vehicle charging systems used in the above exemplary embodiments may be realized by a computer program which causes a computer that constitutes the corresponding vehicle charging system to use its hardware and perform corresponding processing described above.

While exemplary embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. Namely, the present invention is not limited to the configurations illustrated in the drawings

Finally, suitable modes of the present invention will be summarized.

### [Mode 1]

(See the vehicle charging system according to the above first aspect)

### [Mode 2]

In the vehicle charging system,

the information acquisition part may acquire, as the information for determining whether to allow charging, identification information that is held by the vehicle and that identifies a charging service user, and

when the charging service user corresponding to the identification information is registered in a predetermined user database, the charging control part may allow the charging apparatus to perform the charging operation.

### [Mode 3]

In the vehicle charging system,

the information acquisition part may acquire, as the information for determining whether to allow charging, at least two kinds of identification information that is held by the vehicle and that identifies a charging service user, and

when the at least two kinds of identification information is registered as identification information of a single user in a predetermined user database, the charging control part may allow the charging apparatus to perform the charging operation.

### [Mode 4]

The vehicle charging system may further include a second information acquisition part configured to acquire charging condition information set for the vehicle by a user, and

the charging control part may determine whether to allow charging based on the information for determining whether to allow charging and the charging condition information.

### [Mode 5]

In the vehicle charging system,

the information acquisition part may acquire information about a unit charging price as the charging condition information, and

the charging control part may control the charging operation of the charging apparatus based on a price for the charging operation of the charging apparatus and the unit charging price.

### [Mode 6]

In the vehicle charging system, when the price for the charging operation of the charging apparatus is equal to or less than the unit charging price, the charging control part may allow the charging apparatus to perform the charging operation.

### [Mode 7]

In the vehicle charging system,

the information acquisition part may acquire information about a free capacity of a storage battery mounted on the vehicle as the charging condition information, and

the charging control part may control the charging operation of the charging apparatus based on a volume of the free capacity.

### [Mode 8]

In the vehicle charging system, when the volume of the free capacity is equal to or more than a predetermined value, the charging control part may allow the charging apparatus to perform the charging operation.

### [Mode 9]

In the vehicle charging system, it is preferable that the information for determining whether to allow charging be information read from a license plate or a bar code of the vehicle.

### [Mode 10]

In the vehicle charging system, it is preferable that the information for determining whether to allow charging be user information received from a communication apparatus of the vehicle

### [Mode 11]

In the vehicle charging system, it is preferable that the information for determining whether to allow charging be a captured image of a body of the vehicle or feature information from the captured image.

### [Mode 12]

In the vehicle charging system,

information obtained from the information acquisition part may be used as information for determining whether a vehicle exists in a charging space, and

after a vehicle is charged, a predetermined charging completion notification(s) may be transmitted to the user of the vehicle.

### [Mode 13]

The vehicle charging system may further include a vehicle movement part configured to move the vehicle, and

the charging control part may control the vehicle movement part to move the vehicle that has been charged from a place where the charging apparatus is installed.

### [Mode 14]

(See the Parking Lot System According to the Above Second Aspect)

### [Mode 15]

(See the Vehicle Charging Method According to the Above Third Aspect)

Modes 14 and 15 can be expanded in the same way as mode 1 is expanded to modes 2 to 13.

The disclosure of each of the above PTLs is incorporated herein by reference thereto. Variations and adjustments of the exemplary embodiments and the examples are possible within the scope of the overall disclosure (including the claims) of the present invention and based on the basic technical concept of the present invention. Various combinations and selections of various disclosed elements (including the elements in the claims, exemplary embodiments, examples, drawings, etc.) are possible within the scope of the disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

11 charging apparatus
12, 12a information acquisition part
13 charging control part
14 user DB
15 charging completion notification part
16 vehicle movement part

1. A vehicle charging system, comprising:
a non-contact charging apparatus that performs non-contact charging on a battery of a vehicle by facing a power receiving coil mounted on the vehicle;
an information acquisition part configured to acquire, from the vehicle, information for determining whether to allow charging on the vehicle; and
a charging control part configured to control a charging operation of the charging apparatus based on information acquired by the information acquisition part.

2. The vehicle charging system according to claim 1, wherein the information acquisition part acquires, as the information for determining whether to allow charging, identification information that is held by the vehicle and that identifies a charging service user, and
wherein, when the charging service user corresponding to the identification information is registered in a predetermined user database, the charging control part allows the charging apparatus to perform the charging operation.

3. The vehicle charging system according to claim 1,
wherein the information acquisition part acquires, as the information for determining whether to allow charging, at least two kinds of identification information that is held by the vehicle and that identifies a charging service user, and
wherein, when the at least two kinds of identification information is registered as identification information of a single user in a predetermined user database, the charging control part allows the charging apparatus to perform the charging operation.

4. The vehicle charging system according to claim 1, further comprising a second information acquisition part configured to acquire charging condition information set for the vehicle by a user,
wherein the charging control part determines whether to allow charging based on the information for determining whether to allow charging and the charging condition information.

5. The vehicle charging system according to claim 4,
wherein the information acquisition part acquires information about a unit charging price as the charging condition information, and
wherein the charging control part controls the charging operation of the charging apparatus based on a price for the charging operation of the charging apparatus and the unit charging price.

6. The vehicle charging system according to claim 5, wherein, when the price for the charging operation of the charging apparatus is equal to or less than the unit charging price, the charging control part allows the charging apparatus to perform the charging operation.

7. The vehicle charging system according to claim 4,
wherein the information acquisition part acquires information about a free capacity of a storage battery mounted on the vehicle as the charging condition information, and
wherein the charging control part controls the charging operation of the charging apparatus based on a volume of the free capacity.

8. The vehicle charging system according to claim 7, wherein, when the volume of the free capacity is equal to or more than a predetermined value, the charging control part allows the charging apparatus to perform the charging operation.

9. The vehicle charging system according to claim 1, wherein the information for determining whether to allow charging is information read from a license plate or a bar code of the vehicle.

10. The vehicle charging system according to claim 1, wherein the information for determining whether to allow charging is user information received from a communication apparatus of the vehicle.

11. The vehicle charging system according to claim 1, wherein the information for determining whether to allow charging is a captured image of a body of the vehicle or feature information from the captured image.

12. The vehicle charging system according to claim 1,
wherein information obtained from the information acquisition part is used as information for determining whether a vehicle exists in a charging space, and
wherein, after a vehicle is charged, a predetermined charging completion notification(s) is transmitted to the user of the vehicle.

13. The vehicle charging system according to claim 1, further comprising a vehicle movement part configured to move the vehicle,
wherein the charging control part controls the vehicle movement part to move the vehicle that has been charged from a place where the charging apparatus is installed.

14. A parking lot system, comprising:
a non-contact charging apparatus that performs non-contact charging on a battery of a vehicle by facing a power receiving coil mounted on the vehicle;
an information acquisition part configured to acquire, from the vehicle, information for determining whether to allow charging on the vehicle;
a charging control part configured to control a charging operation of the charging apparatus based on information acquired by the information acquisition part; and
a vehicle movement part configured to move a vehicle that has been charged from a place where the charging apparatus is installed.

15. A vehicle charging method, comprising:
causing a charging control apparatus, which is included in a vehicle charging system including a non-contact charging apparatus that performs non-contact charging on a battery of a vehicle by facing a power receiving coil mounted on the vehicle and information acquisition part configured to acquire, from the vehicle, information for determining whether to allow charging on the vehicle, to acquire, from the vehicle, information for determining whether to allow charging on the vehicle; and
causing the charging control apparatus to control a charging operation of the charging apparatus based on the acquired information.

16. The vehicle charging system according to claim 2, wherein the information acquisition part acquires, as the information for determining
whether to allow charging, at least two kinds of identification information that is held by the vehicle and that identifies a charging service user, and
wherein, when the at least two kinds of identification information is registered as identification information of a single user in a predetermined user database, the charging control part allows the charging apparatus to perform the charging operation.

17. The vehicle charging system according to claim 2, further comprising a second information acquisition part configured to acquire charging condition information set for the vehicle by a user,
wherein the charging control part determines whether to allow charging based on the information for determining whether to allow charging and the charging condition information.

18. The vehicle charging system according to claim 3, further comprising a second information acquisition part configured to acquire charging condition information set for the vehicle by a user,
wherein the charging control part determines whether to allow charging based on the information for determining whether to allow charging and the charging condition information.

19. The vehicle charging system according to claim 17,
wherein the information acquisition part acquires information about a unit charging price as the charging condition information, and
wherein the charging control part controls the charging operation of the charging apparatus based on a price for the charging operation of the charging apparatus and the unit charging price.

20. The vehicle charging system according to claim 18,
wherein the information acquisition part acquires information about a unit charging price as the charging condition information, and
wherein the charging control part controls the charging operation of the charging apparatus based on a price for the charging operation of the charging apparatus and the unit charging price.
